(19) United States
(12) Patent Application Publication
(10) Pub. No.: US 2002/0147261 A1
(43) Pub. Date: Oct. 10, 2002

(54) Impact-modified polycarbonate compositions

(76) Inventors: Holger Warth, Dormagen (DE); Dieter Wittmann, Leverkusen (DE); Bernd Keller, Geldern (DE); Martin Haussler, Remscheid (DE)

Correspondence Address: BAYER CORPORATION, PATENT DEPARTMENT, 100 BAYER ROAD, PITTSBURGH, PA, 15205, US

(21) Appl. No.: 10/027,870

(22) Filed: Oct. 26, 2001

(30) Foreign Application Priority Data
Nov. 2, 2000 (DE) 10054275.1

(51) Int. Cl. C08L 1/00

(52) U.S. Cl. 524/451

(57) ABSTRACT

A polycarbonate molding composition is disclosed. The composition which contains 40-95 parts by weight (pbw) of aromatic polycarbonate and/or polyester carbonate, 0-45 pbw of a (co)polymer based on vinyl monomers, 1-25 pbw of silicone acrylate graft rubber and 0.4-40 pbw of mineral filler is characterized by its improved aging properties.

### FIELD OF THE INVENTION

The present invention relates to polycarbonate molding compositions and more particularly to compositions containing silicone acrylate graft rubbers and mineral filler.

### SUMMARY OF THE INVENTION

A polycarbonate molding composition is disclosed. The composition which contains 40-95 parts by weight (pbw) of aromatic polycarbonate and/or polyester carbonate,0-45 pbw of a (co)polymer based on vinyl monomers, 1-25 pbw of silicone acrylate graft rubber and 0.4-40 pbw of mineral filler is characterized by its improved aging properties.

### BACKGROUND OF THE INVENTION

EP-A 663 425 discloses the improvement of impact strength, particularly at low temperatures, by the addition of two specific types of rubber to polycarbonate resin having a defined structure. The specific types of rubber are constituted by a grafted rubber complex comprising polyorganosiloxanes and polyalkyl (meth)acrylate. Glass fibers are mentioned generally as conventional additives.

U.S. Pat. No. 5,807,914 describes glass fiber-reinforced polycarbonate mixtures comprising the specific rubber complex already mentioned in EP-A 663 423, with the mixture being characterized in that a polycarbonate mixture prepared from conventional polycarbonate with from 1 to 20 wt. % oligomeric aromatic polycarbonate is utilized. This resin mixture is distinguished according to U.S. Pat. No. 5,807,914 by good processability, good surface structure, stiffness and impact strength.

The object of the present invention is to improve the aging stability, in particular the heat aging performance and the surface quality, as well as the processability of thermoplastic compositions and moldings produced therefrom.

### DETAILED DESCRIPTION OF THE INVENTION

It has now been found that compositions comprising polycarbonate, silicone acrylate graft rubber and (co)polymer based on vinyl monomers as well as mineral fillers, in particular glass fibers have the desired property profile.

The present invention consequently provides polycarbonate compositions comprising

A) 40-95, preferably 45-90, in particular 55-80 parts by weight of aromatic polycarbonate and/or polyester carbonate

B) 0-45, preferably 5-40, particularly preferably 10-35 and most particularly preferably 15-30 parts by weight of (co)polymer based on vinyl monomers

C) 1-25, preferably 2-20, in particular 3-15 parts by weight of silicone acrylate graft rubber and

D) 0.4-1, preferably 1-30, particularly preferably 3-20, in particular 5-18 parts by weight of mineral filler,

wherein the sum of the parts by weights of components A to D is 100.

Component A

Aromatic polycarbonates and/or aromatic polyester carbonates corresponding to the component A which are suitable according to the invention are known from the literature or are prepared by methods known from the literature (for the preparation of aromatic polycarbonates see, for example, Schnell, “Chemistry and Physics of Polycarbonates”, Interscience Publishers, 1964, as well as DE-AS 1 495 626, DE-A 2 232 877, DE-A 2 703 376, DE-A 2 714 544, DE-A 3 000 610, DE-A 3 832 396; and, for example DE-A 3 077 934 for the preparation of aromatic polyester carbonates).

Aromatic polycarbonates are prepared, for example, by transesterification of diphenols with carbonic acid halides, preferably phosgene and/or with aromatic dicarboxylic acid dihalides, preferably benzenedicarboxylic acid dihalides, by the interfacial process, optionally with the use of chain terminators, for example monophenols and optionally with the use of trifunctional or higher-functional branching agents, for example triphenols or tetraphenols.

Diphenols for the preparation of the aromatic polycarbonates and/or aromatic polyester carbonates are preferably those such as correspond to the formula (I)

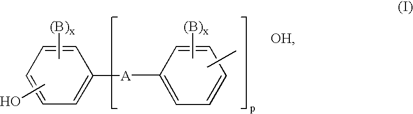

wherein

A is a single bond, C₁-C₅-alkylene, C₂-C₅-alkylidene, C₅-C₆-cycloalkylidene, —O—, —SO—, —CO—, —S—, —SO₂—, C₆-C₁₂-arylene, on to which further aromatic rings which optionally comprise heteroatoms may be condensed, or a radical corresponding to the formula (II) or (III)

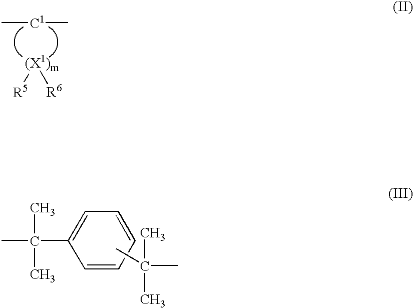

B is in each case C₁-C₁₂-alkyl, preferably methyl, halogen, preferably chlorine and/or bromine

x is, in each case independently of one another, 0, 1 or 2,

p is 1 or 0, and

R⁵ and R⁶ are individually selectable for each X¹ and denote, independently of one another, hydrogen or C₁-C₆-alkyl, preferably hydrogen, methyl or ethyl,

X¹ denotes carbon, and

m denotes an integer of 4 to 7, preferably 4 or 5, with the proviso that R⁵ and R⁶ are simultaneously alkyl on at least one atom X¹.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxy-phenyl) sulfones and α,α-bis(hydroxyphenyl) diisopropyl benzenes, as well as derivatives thereof which are brominated in the ring and/or chlorinated in the ring.

Particularly preferred diphenols are 4,4′-dihydroxydiphenyl, bisphenol A, 2,4-bis(4-hydroxyphenyl)-2-methyl butane, 1,1-bis(4-hydroxyphenyl) cyclohexane, 1,1 -bis(hydroxyphenyl)-3,3,5-trimethyl cyclohexane, 4,4′-dihydroxydiphenyl sulfide, 4,4′-dihydroxydiphenyl sulfone, as well as derivatives thereof which are di- and tetrabrominated or chlorinated, such as, for example, 2,2-bis(3-chloro-4-hydroxyphenyl) propane, 2,2-bis(3,5-dichloro-4-hydroxyphenyl) propane or 2,2-bis(3,5-dibromo-4-hydroxyphenyl) propane.

2,2-Bis(hydroxyphenyl) propane (bisphenol A) is in particular preferred.

The diphenols may be utilized either singly or as any mixtures.

The diphenols are known from the literature or are obtained by processes known from the literature.

Chain terminators which are suitable for the preparation of the thermoplastic aromatic polycarbonates are, for example, phenol, p-chlorophenol, p-tert.-butyl phenol or 2,4,6-tribromophenol, but also long-chain alkyl phenols such as 4-(1,3-tetramethylbutyl) phenol according to DE-A 2 842 005 or monoalkyl phenol or dialkyl phenols having a total of 8 to 20 C atoms in the alkyl substituents, such as 3,5-di-tert.-butyl phenol, p-isooctyl phenol, p-tert.-octyl phenol, p-dodecyl phenol, 2-(3,5-dimethylheptyl)phenol and 4-(3,5-dimethylheptyl)phenol. The quantity of chain terminators to be utilized is generally between 0.5 mol. % and 10 mol. %, in relation to the molar sum of the diphenols utilized in each case.

The thermoplastic aromatic polycarbonates have average weight average molecular weights (M_{w}, measured, for example, by ultracentrifuging or light scattering) of 10000 to 200000, preferably 15000 to 80000.

The thermoplastic aromatic polycarbonates may be branched in known manner, specifically preferably by the incorporation of from 0.05 to 2.0 mol. %, in relation to the sum of diphenols utilized, of trifunctional or higher-functional compounds, for example those such as have three or more phenolic groups.

Both homopolycarbonates and also copolycarbonates are suitable. From 1 to 25 wt. %, preferably 2.5 to 25 wt. % (in relation to the total quantity of diphenols to be utilized) of polydiorganosiloxanes terminating in hydroxy-aryloxy groups may also be used for the preparation of copolycarbonates corresponding to the component A according to the invention. These are known (see, for example, U.S. Pat. No. 3,419,634) or are prepared by processes known from the literature. The preparation of copolycarbonates which comprise polydiorganosiloxane is described, for example, in DE-A 3 334 782.

Besides the bisphenol A homopolycarbonates, the copolycarbonates of bisphenol A having up to 15 mol. %, in relation to the molar sum of diphenols, of diphenols other than those named as preferred or particularly preferred, in particular 2,2-bis(3,5-dibromo-4-hydroxyphenyl) propane, are preferred polycarbonates.

Aromatic dicarboxylic acid dihalides for the preparation of aromatic polyester carbonates are preferably the diacid dichlorides of isophthalic acid, terephthalic acid, diphenylether-4,4′-dicarboxylic acid and naphthalene-2,6-dicarboxylic acid.

Mixtures of the diacid dichlorides of isophthalic acid and of terephthalic acid in a ratio between 1:20 and 20:1 are particularly preferred.

A carbonic acid halide, preferably phosgene, is additionally co-used as a bifunctional acid derivative in the preparation of polyester carbonates.

Besides the monophenols already named, chlorocarbonic esters thereof as well as the acid chlorides of aromatic monocarboxylic acids which may optionally be substituted with C₁-C₂₂-alkyl groups or with halogen atoms, as well as aliphatic C₂-C₂₂-monocarboxylic acid chlorides are considered as chain terminators for the preparation of the aromatic polyester carbonates.

The quantity of chain terminators is in each case from 0.1 to 10 mol. %, in relation to moles of diphenols in the case of the phenolic chain terminators, and moles of dicarboxylic acid dichlorides in the case of monocarboxylic acid chloride chain terminators.

The aromatic polyester carbonates may also comprise incorporated aromatic hydroxycarboxylic acids.

The aromatic polyester carbonates may both be linear and also be branched in known manner (in this context see also DE-A 2 940 024 and DE-A 3 007 934).

The following may be used as branching agents: for example trifunctional or higher-functional carboxylic acid chlorides such as trimesic acid trichloride, cyanuric acid trichloride, 3,3′, 4,4′-benzophenone tetracarboxylic acid tetrachloride, 1,4,5,8-naphthalene tetracarboxylic acid tetrachloride or pyromellitic acid tetrachloride, in quantities of from 0.01 to 1.0 mol. % (in relation to dicarboxylic acid dichlorides utilized) or trifunctional or higher-functional phenols such as phloroglucin, 4,6-dimethyl-2 ,4 ,6-tri-(4-hydroxyphenyl)-hept-2-ene, 4,4-dimethyl-2 ,4,6-tri(4-hydroxyphenyl) heptane, 1,3,5-tri(4-hydroxyphenyl) benzene, 1,1,1-tri-(4-hydroxyphenyl) ethane, tri(4-hydroxyphenyl) phenyl methane, 2,2-bis[4,4-bis(4-hydroxyphenyl)-cyclohexyl] propane, 2,4-bis(4-hydroxyphenylisopropyl) phenol, tetra(4-hydroxyphenyl) methane, 2,6-bis-(2-hydroxy-5-methylbenzyl)-4-methyl phenol, 2-(4-hydroxyphenyl)-2-(2,4-dihydroxyphenyl) propane, tetra(4-[4-hydroxyphenyl isopropyl]-phenoxy methane, 1,4-bis-(4,4′-dihydroxytriphenyl) methyl) benzene in quantities of from 0.01 to 1.0 mol. %, in relation to diphenols utilized. Phenolic branching agents may be introduced in an initial charge with the diphenols, acid chloride branching agents may be introduced together with the acid dichlorides.

The carbonate structural unit content of the thermoplastic aromatic polyester carbonates may be varied at will. The carbonate group content is preferably up to 100 mol. %, in particular up to 80 mol. %, particularly preferably up to 50 mol. %, in relation to the sum of ester groups and carbonate groups. Both the ester and also the carbonate content of the aromatic polyester carbonates may be present in the form of blocks or randomly distributed in the polycondensate.

The relative solution viscosity (ηᵣₑₗ) of the aromatic polycarbonates and polyester carbonates is within the range 1.18 to 1.4, preferably 1.20 to 1.32 (measured on solutions of 0.5 g polycarbonate or polyester carbonate in 100 ml methylene chloride solution at 25° C. ).

The thermoplastic aromatic polycarbonates and polyester carbonates may be utilized alone or in any mixture.

Component B

The following are suitable as vinyl (co)polymers B): polymers prepared from at least one monomer from the group comprising the vinyl aromatics, vinyl cyanides (unsaturated nitriles), (meth)acrylic acid-(C₁-C₈)-alkyl esters, unsaturated carboxylic acids as well as derivatives (such as anhydrides and imides) of unsaturated carboxylic acids. (Co)polymers of

B.1 50 to 99, preferably 60 to 80 parts by weight of vinyl aromatics and/or vinyl aromatics substituted in the ring, such as, for example and preferably, styrene, α-methyl styrene, p-methyl styrene, p-chlorostyrene) and/or methacrylic acid-(C₁-C₈)-alkyl esters such as, for example and preferably, methyl methacrylate, ethyl methacrylate, and

B.2 1 to 50, preferably 20 to 40 parts by weight of vinyl cyanides (unsaturated nitriles) such as acrylonitrile and methacrylonitrile and/or (meth)acrylic acid-(C₁-C₈)-alkyl esters (such as, for example and preferably, methyl methacrylate, n-butyl acrylate, t-butyl acrylate) and/or unsaturated carboxylic acids (such as maleic acid) and/or derivatives (such as anhydrides and imides) of unsaturated carboxylic acids (for example and preferably, maleic anhydride and N-phenyl maleinimide) are in particular suitable.

The (co)polymers B) are resinous, thermoplastic and rubber-free.

The copolymer of B.1 styrene and B.2 acrylonitrile is particularly preferred.

The (co)polymers according to B) are known and may be prepared by free radical polymerization, in particular by emulsion, suspension, solution or bulk polymerization. The (co)polymers corresponding to the component C.1 preferably have molecular weights M_{w} (weight average, determined by light scattering or sedimentation) of between 15 000 and 200 000.

Component C

Suitable silicone acrylate graft rubbers C) according to the invention are prepared by graft polymerization of aromatic alkenyl compounds and a vinylcyanide onto a composite rubber comprising a polyorganosiloxane rubber component and a polyalkyl acrylate or polyalkyl methacrylate component. The composite rubber comprises from 10-90 wt. % polyorganosiloxane rubber and from 90 to 10 wt. % polyalkyl acrylate rubber or polyalkyl methacrylate rubber and has a structure in which the polyorganosiloxane rubber and the polyalkyl acrylate rubber or polyalkyl methacrylate rubber interpenetrate such that the respective rubber components substantially cannot be separated from one another. The composite rubber has an average particle size of from 0.08 to 0.6 μm. The aromatic compounds and the vinyl cyanide compounds are grafted onto the composite rubber and thus form the silicone acrylate graft rubber C).

The silicone acrylate graft rubber is known and is described, for example, in EP-A 663,452 and U.S. Pat. No. 5,807,914. That which is described in U.S. Pat. No. 5,807,914, incorporated herein by reference is preferable as a silicone acrylate graft rubber which is suitable according to the invention. The polyorganosiloxane rubber component can be prepared by emulsion polymerization of organosiloxanes named hereinbelow and a branching agent (I).

The organosiloxane rubber comprises as monomer building units, for example and preferably, dimethyl siloxane or cyclic organosiloxanes having at least 3 members in the ring, preferably from 3 to 6 members in the ring, such as, for example and preferably, hexamethyl cyclotrisiloxane, octamethyl cyclotetrasiloxane, decamethyl cyclopentasiloxane, dodecamethyl cyclohexasiloxane, trimethyl triphenyl cyclotrisiloxanes, tetramethyl tetraphenyl cyclotetrasiloxanes, octaphenyl cyclotetrasiloxane.

The organosiloxane monomers may be utilized alone or in the form of mixtures with 2 or more monomers. The polyorganosiloxane rubber preferably comprises not less than 50 wt. % and particularly preferably not less than 70 wt. % of organosiloxane, in relation to the total weight of the polyorganosiloxane rubber component.

Silane-based branching agents having a functionality of 3 or 4, particularly preferably 4, are preferably used as branching agents (I). The following might be named for example and preferably: trimethoxymethyl silane, triethoxyphenyl silane, tetramethoxy silane, tetraethoxy silane, tetra-n-propoxy silane, tetrabutoxy silane. Tetraethoxy silane is particularly preferred.

The branching agent may be utilized alone or in a mixture of two or more.

Grafting agents (II) which suitable to form structures correspond to the following formulae:

CH₂═C(R²)—COO—(CH₂)ₚ—SiR¹ₙO_{(3-n)/2} (II-1)

CH₂═CH—SiR¹ₙO_{(3-n)/2} (II-2)

or

HS—(CH₂)ₚ—SiR¹ₙO_{(3-n)/2} (II-3),

wherein

R¹ stands for C₁-C₄-alkyl, preferably methyl, ethyl or propyl, or phenyl,

R² stands for hydrogen or methyl,

n denotes 0, 1 or 2, and

p denotes a number from 1 to 6.

Acryloyl oxysilanes or methacryloyl oxysilanes are particularly suitable for forming the aforesaid structure (I-1) and are highly effective for grafting.

The following are preferred:

β-methacryloyloxyethyl dimethoxymethyl silane, γ-methacryloyloxypropyl methoxydimethyl silane, γ-methacryloyloxypropyl dimethoxymethyl silane, γ-methacryloyloxypropyl trimethoxy silane, γ-methacryloyloxypropyl ethoxydiethyl silane, θ-methacryloyloxypropyl diethoxydiethyl silane, δ-methacryloyloxybutyl diethoxydimethyl silanes or mixtures thereof.

From 0 to 10 wt. % grafting agent, in relation to the total weight of the polyorganosiloxane rubber, are preferably utilized.

The polyalkyl acrylate rubber or polyalkyl methacrylate rubber components may be prepared from alkyl acrylate or alkyl methacrylate, a branching agent (III) and a grafting agent (IV).

Methyl acrylate, ethyl acrylate, n-propyl acrylate, 2-ethylhexyl acrylate, n-butyl acrylate, hexyl methacrylate, n-lauryl methacrylate or mixtures thereof are examples of alkyl acrylate and alkyl methacrylate which are preferable. n-Butyl acrylate is particularly preferred. Branching agents (III) are, for example and preferably, ethylene glycol, dimethyl acrylate, propylene glycol dimethacrylate, 1,3-butylene glycol dimethacrylate, 1,4-butylene glycol dimethacrylate or mixtures thereof.

Grafting agents (IV) are, for example and preferably, aryl methacrylate, triaryl cyanurate, triaryl isocyanurate or mixtures thereof. Aryl methacrylate may likewise be utilized as a branching agent. Aryl preferably stands for phenyl.

The total quantity of branching agent (III) and grafting agent (IV) is from 0.1 to 20 wt. %, based on the total weight of the polyalkyl acrylate rubber or polymethacrylate rubber.

The polyorganosiloxane rubber component and the polyalkyl acrylate rubber or polyalkyl methacrylate rubber component are prepared as described in U.S. Pat. No. 5,807,914.

The composite rubber preferably has a gel content of >80 wt. %, measured by extraction of a soluble component thereof in toluene at 90° C. for 12 hours.

The vinyl-based monomers which may be grafted onto the composite rubber are aromatic alkenyl compounds such as, for example and preferably, styrene, α-methyl styrene or vinyl toluene, and/or vinyl cyanide compounds, preferably acrylonitrile and/or methacrylonitrile.

A small quantity of methacrylates such as methyl methacrylate or 2-ethylhexyl methacrylate or acrylates such as methyl acrylate, ethyl acrylate or butyl acrylate may additionally be co-comprised in the vinyl-based monomer. The combination of styrene and acrylonitrile is most particularly preferred as the grafting monomers. The ratio by weight of aromatic alkenyl compound to vinyl cyanide compound is preferably within the range 5:95 to 95:5, particularly preferably 15:75 to 75:15, most particularly preferably 20:80 to 80:20.

The preparation of the grafted composite rubber is likewise described in U.S. Pat. No. 5,807,914.

The silicone acrylate graft rubbers named as the component C are commercially available. Metablen® SRK 200 and Metablen® S 2001 from Mitsubishi Rayon Co. Ltd. might be named as examples.

Component D

Mineral fillers and reinforcing materials in the sense of the invention are those, which increase the E-modulus and which reduce the shrinkage.

Glass fibers, glass spheres, mica, silicates, quartz, talc, titanium dioxide, wollastonite, including in surface-treated form, may, inter alia, be utilized as the mineral fillers. The preferred reinforcing materials are commercial glass fibers. The glass fibers, which generally have a fiber diameter of 8 to 14 μm, may be utilized as continuous strands or as chopped strands or milled glass fibers; the fibers may be treated with a suitable sizing system and a coupling agent or coupling agent system based on silane.

Component E

Extremely finely divided inorganic powders may also be included.

These preferably consist of at least one polar compound of one or more metals from the 1st to 5th main groups or the 1st to 8th sub-groups of the Periodic Table, preferably the 2nd to 5th main groups or the 4th to 8th sub-groups, particularly preferably the 3rd to 5th main groups or the 4th to 8th sub-groups, or prepared from compounds of these metals with at least one element selected from among oxygen, hydrogen, sulfur, phosphorus, boron, carbon, nitrogen or silicon.

Preferred compounds are, for example, oxides, hydroxides, hydrated oxides, sulfates, sulfites, sulfides, carbonates, carbides, nitrates, nitrites, nitrides, borates, silicates, phosphates, hydrides, phosphites or phosphonates.

The extremely finely divided inorganic powders preferably consist of oxides, phosphates, hydroxides, preferably of TiO₂, SiO₂, SnO₂, ZnO, ZnS, boehmite, ZrO₂, Al₂O₃, aluminum phosphates, iron oxides, furthermore TiN, WC, AlO(OH), Sb₂O₃, iron oxides, Na₂SO₄, vanadium oxides, zinc borate, silicates such as Al silicates, Mg silicates, one-, two-, three-dimensional silicates. Mixtures and doped compounds are likewise usable.

These nanoscale particles may furthermore be surface-modified with organic molecules in order to achieve greater compatibility with the polymers. Hydrophobic or hydrophilic surfaces can be created in this manner.

Aluminum oxide hydrates, for example boehmite, or TiO₂ are particularly preferred.

The average particle diameters of the nanoparticles are smaller than or equal to 200 nm, preferably smaller than or equal to 150 nm, in particular 1 to 100 nm.

Particle size and particle diameter always signify the mean particle diameter d₅₀, determined by ultracentrifuge measurements as described by W. Scholtan et al., Kolloid-Z. und Z. Polymere 250 (1972), pp. 782-796.

The inorganic extremely finely divided compounds may be present as powders, pastes, sols, dispersions or suspensions. Powders may be obtained from dispersions, sols or suspensions by precipitation.

The powders may be incorporated into the thermoplastic molding compositions by conventional methods, for example by direct kneading or extrusion of molding compositions and the extremely finely divided inorganic powders. The preferred methods are the preparation of a master batch, for example in flame-retardant additives, and at least one component of the molding compositions according to the invention in monomers or solvents, or the co-precipitation of a thermoplastic component and the extremely finely divided inorganic powders, for example by co-precipitation of an aqueous emulsion and the extremely finely divided inorganic powders, optionally in the form of dispersions, suspensions, pastes or sols of the extremely finely divided inorganic materials.

Glass fibers or glass spheres are particularly preferred.

The compositions according to the invention may comprise at least one of the conventional additives such as lubricants and mould release agents, for example pentaerythritol tetrastearate, nucleating agents, antistatic agents, stabilizers of the component D, various fillers and reinforcing materials as well as dyes and pigments.

The compositions according to the invention comprising the components A to D and optionally additives are prepared by mixing the respective constituents in known manner and melt-compounding and melt-extrusion then at temperatures of from 200° C. to 300° C. in conventional units such as internal mixers, extruders and twin-screw units, with the component F being preferably utilized in the form of the aforementioned coagulated mixture.

The individual constituents may be mixed in known manner both in successive and also simultaneous manner, specifically both at approximately 20° C. (room temperature) and also at elevated temperature.

The invention therefore also provides a process for the preparation of the molding compositions.

The molding compositions of the present invention may be used for the production of all kinds of molded bodies. Molded bodies may in particular be produced by injection molding. Examples of molded bodies which may be produced are: all kinds of housing components, for example for domestic appliances such as juice presses, coffee machines, mixers and office machines such as monitors, printers, copiers, or covering plates for the construction sector and automotive components such as, for example, instrument panel supports or covers. Safety components for airbag covers are particularly preferred. Owing to their very good electrical properties, they may moreover be utilized in the electrotechnical field.

The molding compositions according to the invention may furthermore be used, for example, for the production of the following molded bodies and moldings:

interior fittings for rail vehicles, hub caps, housings of electrical appliances containing small transformers, housings for apparatus for the dissemination and transmission of information, housings and casing for medical purposes, massage equipment and housings for the lafter, toy vehicles for children, flat wall elements, housings for safety devices, rear spoilers, thermally insulated transport containers, equipment for the housing or care of small animals, moldings for sanitary and bathroom fittings, covering grates for fan vents, moldings for conservatories and sheds, housings for garden equipment.

A further form of processing is the production of molded bodies by thermoforming from previously prepared sheet or film.

The present invention therefore also provides the use of the molding compositions according to the invention for the preparation of all kinds of molded bodies, preferably those mentioned above, as well as the molded bodies produced from the molding compositions according to the invention.

### EXAMPLES

Component A.1

Linear polycarbonate based on bisphenol A, having a relative solution viscosity of 1.272, measured in CH₂Cl₂ as the solvent at 25° C. and at a concentration of 0.5 g/100 ml.

Component A.2

Linear polycarbonate based on bisphenol A, having a relative solution viscosity of 1.202, measured in CH₂Cl₂ as the solvent at 25° C. and at a concentration of 0.5 g/100 ml.

Component B

Styrene/acrylonitrile copolymer having a ratio by weight of styrene to acrylonitrile of 72:28 and an intrinsic viscosity of 0.55 dl/g (measured in dimethyl formamide at 20° C.).

Component C

C.1: Metablen® S 2001 (methyl methacrylate-butyl acrylate dimethyl siloxane copolymer) from Mitsubishi Rayon Co. Ltd.

C.2: Metablen® SRK 200 (methyl methacrylate-butyl acrylate dimethyl siloxane copolymer) from Mitsubishi Rayon Co. Ltd.

Comparison component C*

Graft polymer of 40 parts by weight of a copolymer prepared from styrene and acrylonitrile in the ratio 73:27 onto 60 parts by weight of particulate cross-linked polybutadiene rubber (average particle diameter d₅₀=0.28 μm), prepared by emulsion polymerization.

Component D

D-1: Glass fibers CS 7942, from Bayer AG, Leverkusen

Additives

Pentaerythritol tetrastearate, phosphite stabilizer.

Preparation and testing of the molding compositions according to the invention

The components are mixed in a 3-liter internal mixer. The molded bodies are produced on an Arburg 270 E injection molding machine at 260° C.

The properties of the molding compositions according to the invention are shown in Table 1 below:

TABLE 1
Composition and properties

| | 1 | | |
|---|---|---|---|
| Examples | (comparison) | 2 | 3 |
| Components [parts/wt] | | | |
| A1 | 68 | 20 | 20 |
| A2 | — | 48 | 48 |
| B | 16 | 26 | 26 |
| C1 | — | 6 | — |
| C2 | — | — | 6 |
| C* | 16 | — | — |
| D1 | 11 | 11 | 11 |
| D2 | — | — | — |
| Pentaerythritol | 0.5 | 0.5 | 0.5 |
| tetrastearate | | | |
| Stabilizer | 0.12 | 0.12 | 0.12 |
| Properties: | | | |
| Elastic modulus MPa | 3590 | 3890 | 3850 |
| ISO 527 | | | |
| Vicat B | 131 | 135 | 135 |
| DIN 53 460 | | | |
| ° C. | | | |
| Impact strength 0 h/RT | 26 | 25 | 25 |
| Izod ISO 180-1 U | | | |
| Impact strength | 18 | 24 | 24 |
| 250 h at 120° C. | | | |
| Impact strength | 11 | 23 | 24 |
| 750 h at 120° C. | | | |
| Impact strength | 9 | 23 | 24 |
| 1250 h at 120° C. | | | |
| Shear viscosity | 300 | 200 | 200 |
| 260° C./1000/s | | | |
| ISO 11443 | | | |
| Surface | 0 | + | + |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A molding composition comprising
A) 40-95 parts by weight (in relation to 100 parts by weight of the total composition) of aromatic polycarbonate and/or polyester carbonate
B) 0-45 parts by weight (in relation to 100 parts by weight of the total composition) of (co)polymer based on vinyl monomers
C) 1-25 parts by weight (in relation to 100 parts by weight of the total composition) of silicone acrylate graft rubber and
D) 0.4-40 parts by weight (in relation to 100 parts by weight of the total composition) of mineral filler.

2. The composition according to claim 1, in which component C is prepared by graft polymerization of aromatic alkenyl compounds and a vinylcyanide onto a composite rubber that contains a polyorganosiloxane rubber component and a polyalkyl(meth)acrylate.

3. The composition according to claim 1, wherein component B is a (co)polymer of at least one monomer selected from the group consisting of vinyl aromatics, vinyl cyanides, methacrylic acid-(C₁-C₈)-alkyl esters, unsaturated carboxylic acids and derivatives of unsaturated carboxylic acids.

4. The composition according to claim 1, wherein component B is a copolymer of
B.1 from 50 to 99 parts by weight (in relation to 100 parts by weight of
B) of vinyl aromatics and/or methacrylic acid-(C₁-C₈)-alkyl esters and
B.2 from I to 50 parts by weight (in relation to 100 parts by weight of B) of a member selected from the group consisting of vinyl cyanides methacrylic acid-(C₁-C₈)-alkyl esters, unsaturated carboxylic acids and derivatives of unsaturated carboxylic acids.

5. The composition according to claim 1 further containing 1 to 30 parts by weight of a mineral filler.

6. The composition according to claim 1 further containing at least one member selected from the group consisting of glass fibers, glass spheres, mica, silicates, quartz, talc, titanium dioxide and wollastonite.

7. A method of using the composition according to claim 1 comprising molding an article.

8. The article prepared by the method of claim 7.

9. A molded article comprising the composition of claim 1.
